(19) United States
(12) Patent Application Publication
(10) Pub. No.: US 2025/0385421 A1
(43) Pub. Date: Dec. 18, 2025

(54) MOUNTING SYSTEM AND MOUNTING METHOD FOR BASE STATION ANTENNAS

(71) Applicant: OUTDOOR WIRELESS NETWORKS LLC, Richardson, TX (US)

(72) Inventors: MeiHua Yin, Suzhou (CN); PuLiang Tang, Suzhou (CN); Nengbin Liu, Suzhou (CN); Sha Lv, Suzhou (CN)

(21) Appl. No.: 19/226,654

(22) Filed: Jun. 3, 2025

(30) Foreign Application Priority Data
Jun. 12, 2024 (CN) 202410755965.5

(51) Int. Cl. H01Q 1/12; H01Q 3/06

(52) U.S. Cl. CPC H01Q 1/1207; H01Q 1/125; H01Q 3/06

(57) ABSTRACT

The present disclosure relates to a mounting system and method for base station antennas. Base station antennas comprise passive and active antenna modules, and the mounting system comprises: an upper mounting assembly configured to mount the top of the passive antenna module in a tilt-adjustable manner to a mounting structure; a lower mounting assembly configured to pivotally mount a portion near the bottom of the passive antenna module to the mounting structure; and a mounting kit comprising a first upper mounting bracket, a first lower mounting bracket, and an intermediate mounting assembly pivotally connected to the first lower mounting bracket. The first upper mounting bracket allows the top of the active antenna module to tilt and be displaced along with the top of the passive antenna module during the adjustment of the tilt angle of the passive antenna module; the intermediate mounting assembly allows the portion of the active antenna module near its bottom to be pivotally mounted to the mounting structure, and during the tilt process of the passive antenna module, it allows the bottom of the active antenna module to pivot around the intermediate mounting assembly without allowing the bottom of the active antenna module to be displaced.

### RELATED APPLICATION

The present application claims priority from and the benefit of Chinese Patent Application No. 202410755965.5, filed Jun. 12, 2024, the disclosure of which is hereby incorporated herein by reference in full.

### FIELD OF THE INVENTION

The present disclosure relates to telecommunications equipment. In particular, the present disclosure relates to a mounting system for base station antennas, and to a method of using the mounting system to mount base station antennas and adjust the tilt angles thereof.

### BACKGROUND OF THE INVENTION

Cellular communications systems are well known in this field. In cellular communication systems, geographical areas are divided into a series of “cells” that are serviced by their respective base stations. A base station may comprise one or multiple antennas that are configured to provide two-way radio frequency (“RF”) communications for mobile users within the cells served by the base station. In many cases, each cell is divided into a plurality of “sectors”, with each sector serviced by one or more base station antennas. Typically, base station antennas are mounted on mounting poles, towers, or other raised structures, directing the radiation pattern (also referred to as an “antenna beam”) generated by the base station antennas outward. Base station antennas are often implemented as linear or planar phased arrays of radiating elements.

In order to accommodate the ever-increasing volumes of cellular communications, cellular operators have added cellular services in a variety of new frequency bands. To increase capacity without further increasing the number of base station antennas, multiband base station antennas comprising linear arrays of multiple radiating elements have been introduced. In addition, base station antennas that include multiple “beamforming” arrays of radiating elements, which comprise multiple columns of radiating elements, are now being deployed. Radio devices for these beamforming arrays may be integrated into the antennas, allowing the antennas to perform active beamforming (i.e., the shape of the antenna beam produced by the antenna may be adaptively changed to improve the performance of the antenna). These beamforming arrays typically operate in higher frequency bands, such as portions of the 3.3-5.8 GHz band. Antennas with integrated radio devices are referred to as “active antennas”. Active antennas can produce narrow beamwidth, high-gain antenna beams, and can steer the generated antenna beams in different directions by altering the amplitude and/or phase of the subcomponents of the RF signals transmitted through the antenna.

An existing “active” base station antenna may comprise a passive antenna module (e.g., a 4G antenna module) and an active antenna module (e.g., a 5G antenna module), wherein the active antenna module is typically mounted on the back of the passive antenna module (i.e., the surface of the passive antenna module facing the mounting structure).

Some existing mounting mechanisms typically include a frame structure for mounting the active antenna module that is fixed to the back of the passive antenna module and one or more fastening brackets for further securing the active antenna module. There are some shortcomings in such an installation mechanism. For example, the mounting mechanism is too heavy, the overall cost of the mounting mechanism is relatively high, it is difficult for a technician to tilt the base station antenna without performing multiple steps, and all of the load weight of the active antenna module is transferred to the mounting mechanism and the passive antenna module.

There are also some mounting mechanisms that only pivotally connect the upper part of the active antenna module in the vertical direction to the upper part of the passive antenna module, while the lower part of the active antenna module is directly fixed to the mounting structure (such as a mounting pole, tower, or other mounting structure) via a fastening bracket. There are also shortcomings in such a mounting mechanism. For example, during the process of adjusting the tilt angle of the base station antennas, the fastening bracket at the lower portion of the active antenna module needs to be released to enable the active antenna module to be tilted together with the passive antenna module. However, after releasing the fastening bracket of the lower portion of the active antenna module, the active antenna module will form a cantilever beam that can pivot about the upper portion thereof. On one hand, such “cantilever beam-style” active antenna modules are prone to swinging under the influence of gravity during the tilting process, potentially causing impacts or collisions with the passive antenna module, thereby damaging both the passive antenna module and/or the active antenna module itself. On the other hand, after tilting, it is difficult, due to the force of gravity, to maintain precise parallelism and precise relative distance between such “cantilever beam-style” active antenna modules and the passive antenna module. Additionally, it is also difficult to stop the active antenna module at the desired tilt angle, all of which can affect the performance of the entire base station antenna.

Therefore, alternative mounting systems for base station antennas may be required.

### SUMMARY OF THE INVENTION

In a first aspect of the present disclosure, a mounting system for base station antennas is provided, wherein the base station antenna comprises a passive antenna module and an active antenna module, and the mounting system comprises: an upper mounting assembly configured for mounting the top of the passive antenna module in a tilt-adjustable manner to a mounting structure; a lower mounting assembly configured for pivotally mounting a portion near the bottom of the passive antenna module to the mounting structure; and a mounting kit comprising a first upper mounting bracket, a first lower mounting bracket, and an intermediate mounting assembly pivotally connected to the first lower mounting bracket, wherein the first upper mounting bracket is fixed to the back of the active antenna module facing the mounting structure at a position near the top of the active antenna module, while the first lower mounting bracket is fixed to the back of the active antenna module at a position near the bottom of the active antenna module; wherein, the first upper mounting bracket is configured for connecting the top of the active antenna module to the top of the passive antenna module or to the upper mounting assembly pivotally, allowing the top of the active antenna module to tilt and be displaced along with the top of the passive antenna module during the adjustment of the tilt angle of the passive antenna module; in addition, the intermediate mounting assembly is configured for pivotally mounting the portion near the bottom of the active antenna module to the mounting structure and to allow the bottom of the active antenna module to pivot around the intermediate mounting assembly during the tilting process of the passive antenna module without allowing the bottom of the active antenna module to move.

According to an embodiment of the present disclosure, the intermediate mounting assembly comprises a first intermediate mounting element and a second intermediate mounting element. The first end of the first intermediate mounting element is pivotally connected to the first lower mounting bracket, while the first end of the second intermediate mounting element is pivotally connected to a clamping assembly suitable to be mounted on the mounting structure; in addition, both the second end of the first intermediate mounting element and the second end of the second intermediate mounting element include a central hole and a plurality of adjustment holes distributed along the circumference around the central hole. The second end of the first intermediate mounting element and the second end of the second intermediate mounting element are pivotally connected via a pivot extending through the central hole, and each of the plurality of adjustment holes at the second end of the first intermediate mounting element and the second end of the second intermediate mounting element corresponds to a tilt angle of the active antenna module. When the active antenna module is at a predetermined tilt angle, one of the plurality of adjustment holes at the second end of the first intermediate mounting element that corresponds to the predetermined tilt angle aligns with one of the plurality of adjustment holes at the second end of the second intermediate mounting element that corresponds to the predetermined tilt angle.

According to an embodiment of the present disclosure, the plurality of adjustment holes are unevenly distributed along the circumference.

According to an embodiment of the present disclosure, the intermediate mounting assembly is configured to allow the active antenna module to have a tilt angle between 0° and 12°.

According to an embodiment of the present disclosure, when the active antenna module is at a predetermined tilt angle, fastening elements extend through the two aligned adjustment holes of the first intermediate mounting element and the second intermediate mounting element to secure the active antenna module at the predetermined tilt angle.

According to an embodiment of the present disclosure, the mounting system further comprises a second upper mounting bracket and a second lower mounting bracket. The second upper mounting bracket is fixed to the back of the passive antenna module near the top and pivotally connected to the upper mounting assembly, while the second lower mounting bracket is fixed below the top of the passive antenna module, on the back of the passive antenna module, and is pivotally connected to the lower mounting assembly.

According to an embodiment of the present disclosure, the first upper mounting bracket is pivotally connected to the second upper mounting bracket.

According to an embodiment of the present disclosure, the first upper mounting bracket comprises a hook portion, which is capable of hooking onto the second upper mounting bracket.

According to an embodiment of the present disclosure, the hook portion has a tilt angle relative to the vertical direction, wherein the angle is at least greater than the maximum tilt angle of the passive antenna module.

According to an embodiment of the present disclosure, both the first upper mounting bracket and the second upper mounting bracket are configured in the form of protrusions.

According to an embodiment of the present disclosure, the upper mounting assembly is configured as an extendable sleeve that is capable of tilting downward and expanding along the axial direction.

According to an embodiment of the present disclosure, the upper mounting assembly is provided with an arcuate groove, which is used to connect the top of the passive antenna module, and the connecting element of the upper mounting assembly is positioned in the arcuate groove and is capable of sliding along the arcuate groove.

According to an embodiment of the present disclosure, the mounting system further comprises a clamping assembly. The upper mounting assembly and the lower mounting assembly mount the passive antenna module to the mounting structure with the assistance of the clamping assembly, while the intermediate mounting assembly mounts the active antenna module to the mounting structure with the assistance of the clamping assembly.

In a second aspect of the present disclosure, a method for mounting a base station antenna using the mounting system according to the present disclosure is provided, wherein the base station antenna comprises a passive antenna module and an active antenna module, and the method comprises: using the upper mounting assembly and the lower mounting assembly of the mounting system to mount the passive antenna module at a 0° tilt angle to the mounting structure; using the mounting kit of the mounting system to mount the active antenna module at a 0° tilt angle on the back of the passive antenna module facing the mounting structure, wherein the top of the active antenna module is connected to the top of the passive antenna module or pivotally connected to the upper mounting assembly; tilting the passive antenna module around the lower mounting assembly of the mounting system to a predetermined tilt angle, during the tilting process of the passive antenna module, the top of the active antenna module is displaced along with the top of the passive antenna module and pivots relative to the top of the passive antenna module, while the bottom of the active antenna module only pivots around the intermediate mounting assembly of the mounting kit without being displaced; after the passive antenna module is tilted to the predetermined tilt angle, releasing the intermediate mounting assembly of the mounting kit to allow the bottom of the active antenna module to be displaced towards the passive antenna module until the bottom of the active antenna module is positioned such that the active antenna module is also at the predetermined tilt angle.

According to an embodiment of the present disclosure, the mounting system comprises a second upper mounting bracket and a second lower mounting bracket positioned on the back of the passive antenna module. The method further comprises connecting the second upper mounting bracket and the second lower mounting bracket respectively to the upper mounting assembly and the lower mounting assembly to mount the passive antenna module onto the mounting structure.

According to an embodiment of the present disclosure, the first upper mounting bracket of the mounting kit comprises a hook portion. The method further comprises, after mounting the passive antenna module onto the mounting structure, using the hook portion to hook the active antenna module onto the second upper mounting bracket of the passive antenna module, then using the intermediate mounting assembly of the mounting kit to mount the bottom of the active antenna module onto the mounting structure and keep the active antenna module at the 0° tilt angle.

According to an embodiment of the present disclosure, the intermediate mounting assembly comprises a first intermediate mounting element and a second intermediate mounting element pivotally connected to each other. During the tilting process of the passive antenna module, the first intermediate mounting element and the second intermediate mounting element always remain in positions corresponding to the 0° tilt angle.

According to an embodiment of the present disclosure, both ends of the first intermediate mounting element and the second intermediate mounting element, which are connected to each other, comprise intermediate holes and a plurality of adjustment holes surrounding the central hole and distributed along its circumference, wherein each of the plurality of adjustment holes corresponds to a tilt angle of the active antenna module. When the active antenna module is at the 0° tilt angle, the adjustment hole corresponding to the 0° tilt angle among the plurality of adjustment holes of the first intermediate mounting element is aligned with the adjustment hole corresponding to the 0° tilt angle among the plurality of adjustment holes of the second intermediate mounting element. The method comprises inserting fastening elements into the two adjustment holes corresponding to the 0° tilt angle to keep the first intermediate mounting element and the second intermediate mounting element always in positions corresponding to the 0° tilt angle.

According to an embodiment of the present disclosure, the method comprises removing the fastening elements after the passive antenna module has been tilted to the predetermined tilt angle, causing the bottom of the active antenna module to be displaced towards the passive antenna module.

According to an embodiment of the present disclosure, after the active antenna module has also reached the predetermined tilt angle, the two adjustment holes of the first intermediate mounting element and the second intermediate mounting element of the intermediate mounting assembly corresponding to the predetermined tilt angle are aligned with each other. The method further comprises inserting fastening elements into the two adjustment holes of the first intermediate mounting element and the second intermediate mounting element corresponding to the predetermined tilt angle to maintain the active antenna module at the predetermined tilt angle.

It should be noted that various aspects of the present disclosure described for one example may be included in other different examples, even though specific description is not made for the other different examples. In other words, all the examples and/or features of any example may be combined in any manner and/or combination, as long as they are not contradictory to each other. The applicant reserves the right to amend any claims of the original submission and/or to submit any new claims correspondingly, including the right to modify any claims of the original submission to depend on and/or incorporate any features of any one or more other claims.

### DESCRIPTION OF DRAWINGS

FIG. 1 is a perspective view of a mounting system for a base station antenna according to some embodiments of the present disclosure.

FIG. 2 is a perspective view of a passive antenna module and its mounting bracket assembly, according to some embodiments of the present disclosure.

FIG. 3 is a perspective view of an active antenna module and its mounting bracket assembly according to some embodiments of the present disclosure.

FIG. 4 is a side view of an active antenna module and its mounting bracket assembly and mounting kit according to some embodiments of the present disclosure.

FIG. 5 is a partially enlarged view of an upper mounting bracket of the mounting bracket assembly of the active antenna module and an upper mounting bracket of the mounting bracket assembly of the passive antenna module according to some embodiments of the present disclosure.

FIG. 6 is a partially enlarged view of a mounting kit of an active antenna module according to some embodiments of the present disclosure, wherein the mounting kit is in a first configuration corresponding to a 0° tilt angle.

FIG. 7 is a partially enlarged view of using the mounting kit to mount the lower part of the active antenna module on a fixed structure according to some embodiments of the present disclosure.

FIG. 8 is a partially enlarged view of a mounting kit of an active antenna module according to some embodiments of the present disclosure, wherein the mounting kit is in a second configuration corresponding to a 12° tilt angle.

FIG. 9A to FIG. 11C illustrate, according to some embodiments of the present disclosure, operational steps in the mounting and adjusting of the tilt angle of the base station antenna using the mounting system according to the present disclosure.

It should be understood that in all the attached drawings, the same symbols denote the same elements. In the attached drawings, for clarity, the size of certain feature is not drawn to scale as it may change.

### DETAILED DESCRIPTION OF SPECIFIC EMBODIMENTS

The present disclosure will be described below with reference to the attached drawings, and the attached drawings illustrate certain examples of the present disclosure. However, it should be understood that the present disclosure may be presented in many different ways and is not limited to the examples described below; in fact, the examples described below are intended to make the content of the present disclosure more complete and to fully explain the protection scope of the present disclosure to those skilled in the art. It should also be understood that the examples disclosed in the present disclosure may be combined in various ways so as to provide more additional examples.

It should be understood that the words in the Specification are only used to describe specific examples and are not intended to limit the present disclosure. Unless otherwise defined, all terms (including technical terms and scientific terms) used in the Specification have the meanings commonly understood by those skilled in the art. For brevity and/or clarity, well-known functions or structures may not be further described in detail.

The singular forms “a”, “an”, “the” and “this” used in the Specification all include plural forms unless clearly indicated. The words “include”, “contain” and “have” used in the Specification indicate the presence of the claimed features, but do not exclude the presence of one or a plurality of other features. The word “and/or” used in the Specification includes any or all combinations of one or a plurality of the related listed items.

In the Specification, when it is described that an element is “on” another element, “attached” to another element, “connected” to another element, “coupled” with another element, or “in contact with” another element, etc., the element may be directly on another element, attached to another element, connected to another element, coupled with another element, or in contact with another element, or an intermediate element may be present.

In the Specification, the terms “first”, “second”, “third”, etc. are only used for convenience of description and are not intended for limitation. Any technical features represented by “first”, “second”, “third”, etc. are interchangeable.

In the Specification, terms expressing spatial relations such as “upper”, “lower”, “front”, “rear”, “top”, and “bottom” may describe the relation between one feature and another feature in the attached drawings. It should be understood that, in addition to the positions shown in the attached drawings, the words expressing spatial relations further include different positions of a device in use or operation. For example, when a device in the attached drawings is turned upside down, the features originally described as being “below” other features now can be described as being “above” the other features”. The apparatus may also be oriented in other ways (rotated 90 degrees or in other orientations), and the relative spatial relationships will be interpreted accordingly in those cases.

The present disclosure relates to a mounting system for base station antennas, and to a method of using the mounting system to mount base station antennas and adjust the tilt angles thereof. As used herein, the term “tilt angle” refers to mechanical tilt, which is used to indicate the angle of inclination of the extension direction of the base station antenna relative to the vertical direction.

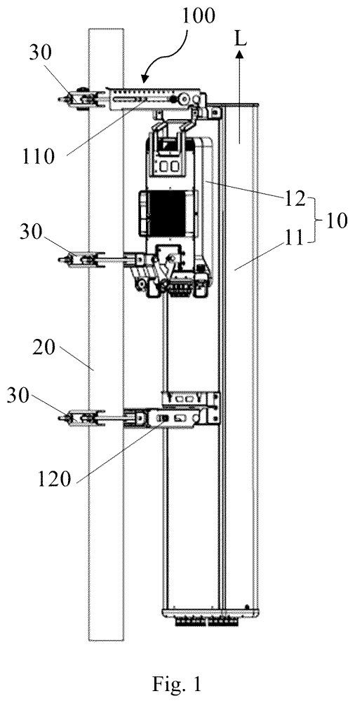

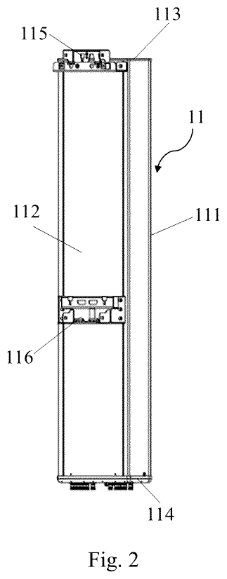

Referring to FIG. 1 to FIG. 3, the base station antenna 10 in the present disclosure may comprise a passive antenna module (e.g., 4G antenna module) 11 and an active antenna module (e.g., 5G antenna modules) 12 that are separable from each other. The passive antenna module 11 and the active antenna module 12 may both extend along the longitudinal direction L of the base station antenna 10, and the longitudinal length of the active antenna module 12 may be less than the longitudinal length of the passive antenna module 11. The base station antenna 10 may be mounted on a mounting structure 20 such as a tower, mounting pole, etc., in a manner substantially parallel to the vertical direction L or tilted by an acute angle relative to the vertical direction, such that the base station antenna 10 is tilted slightly parallel to or relative to the extension direction of the mounting structure 20, e.g., at a tilt angle of 0°-12°. When mounted on the mounting structure 20, the front 111 of the passive antenna module 11 of the base station antenna 10 may be away from the mounting structure 20 and the back 111 [sic: 112] thereof may face the mounting structure 20; the active antenna module 12 may be detachably mounted to the back 112 of the passive antenna module 11, at a position near the top 113 of the passive antenna module 11, and the front 121 of the active antenna module 12 is away from the mounting structure 20 while the back 122 faces the mounting structure 20.

As used herein, the term “passive antenna module” refers to a passive antenna assembly with an array of radiating elements. These radiating elements are coupled to a radio device external to the base station antenna, typically a remote radio head mounted near the passive antenna module 11 (or its housing). The array of radiating elements contained in the passive antenna assembly is configured to form static antenna beams. The passive antenna assembly may comprise radiating elements, such as one or two low-band radiating elements and/or mid-band or high-band radiating elements. The array of radiating elements contained in the passive antenna assembly is configured to form static antenna beams (e.g., each antenna beam is configured to cover one sector of the base station). The passive antenna assembly may include a back plate provided by the reflector, wherein the radiating elements protrude in front of the reflector, and the radiating elements may comprise a linear array of one or a plurality of low-band radiating elements operating in all or a portion of a 617-960 MHz band and/or a linear array of one or a plurality of mid-band radiating elements operating in all or a portion of the 1,427-2,690 MHz frequency band.

As used herein, the term “active antenna module” may be used interchangeably with “active antenna unit”, “AAU”, and “radio device”, which refers to a cellular communication unit comprising a radio circuit and associated antenna elements capable of electronically adjusting the amplitude and/or phase of the sub-components of the RF signals that are output to the different radiating elements in the array or group of radiating elements. The active antenna module 12 may comprise a radio circuit and radiating elements (e.g., a multiple-input multiple-output (mMIMO) beamforming antenna array) and may comprise other components such as a filter, a calibration network, an Antenna Interface Signal Group (AISG) controller, etc. The active antenna module 12 may be provided as a single integrated unit or may be provided as multiple stackable units comprising, for example, a first sub-unit and a second sub-unit, such as a radio electronic unit having a radio circuit and an antenna sub-unit having a multi-column array of radiating elements. The first sub-unit and second sub-unit may be attached together in a stackable manner in the front-to-back direction of the base station antenna 10, wherein the antenna sub-unit is closer to the front (outer radome) of the base station antenna 10 than the radio electronic unit.

According to embodiments of the present disclosure, the base station antenna 10 is mounted on the mounting structure 20 in a tilt-adjustable manner using the mounting system 100. The mounting system 100 may be configured to first mount the base station antenna 10 on the mounting structure 20 with the longitudinal axis L substantially parallel to the vertical direction (i.e., 0° tilt angle), followed by the tilting of the base station antenna 10 to the desired tilt angle relative to the vertical direction. In some embodiments, the mounting system may be configured to tilt the base station antenna 10 at a tilt angle between about 0° and about 12°.

Referring to FIG. 1 to FIG. 4, according to an embodiment of the present disclosure, the mounting system 100 may comprise an upper mounting assembly 110 and a lower mounting assembly 120. The upper mounting assembly 110 is configured to mount the top 113 of the passive antenna module 11 in a tilt-adjustable manner to the mounting structure 20, while the lower mounting assembly 120 is configured to pivotably mount a portion near the bottom 114 of the passive antenna module 11 to the mounting structure 20 at a suitable position below the top 113 of the passive antenna module 11 (e.g., a position near the bottom 114 of the passive antenna module 11). The upper mounting assembly 110 and the lower mounting assembly 120 may be any suitable mounting assembly. For example, in some embodiments, the upper mounting assembly 110 may be configured as an extendable sleeve that may tilt downwardly and may expand along the axial direction (as shown in FIG. 10A and FIG. 11A) to facilitate tilting of the passive antenna module 11 to the desired tilt angle; in some other embodiments, the upper mounting assembly 110 may be provided with an arcuate groove for connecting the top 113 of the passive antenna module 11, and the connecting element of the upper mounting assembly 110 may be provided in the arcuate groove such that it is capable of sliding along the arcuate groove, facilitating the tilting of the passive antenna module 11 to the desired tilt angle. The upper mounting assembly 110 and the lower mounting assembly 120 may be used with the clamping assembly 30 to secure the passive antenna module 11 at a desired height on the mounting structure 20. The clamping assembly 30 may be a standard clamping assembly or other appropriate clamping assembly commonly used in the art, and will not be further described here.

According to an embodiment of the present disclosure, the mounting system 100 may comprise the upper mounting bracket 115 and the lower mounting bracket 116 disposed on the back 112 of the passive antenna module 11. The upper mounting bracket 115 may be fixed to the back 112 of the passive antenna module 11 at a position near the top 113 of the passive antenna module 11, while the lower mounting bracket 116 may be fixed to the back 112 of the passive antenna module 11 at a suitable position below the top 113 of the passive antenna module 11 (e.g., at a position near the bottom 114 of the passive antenna module 11). The upper mounting bracket 115 may be pivotally connected to the upper mounting assembly 110 while the lower mounting bracket 116 may be pivotally connected to the lower mounting assembly 120, which facilitates convenient adjustment of the tilt angle of the passive antenna module 11. When the tilt angle of the passive antenna module 11 is adjusted to the desired tilt angle, fastening elements (e.g., a fastening bolt-nut assembly) may be utilized to secure the connection between the upper mounting bracket 115 and the upper mounting assembly 110, as well as the connection between the lower mounting bracket 116 and the lower mounting assembly 120 to securely retain the passive antenna module 11 at the adjusted tilt angle.

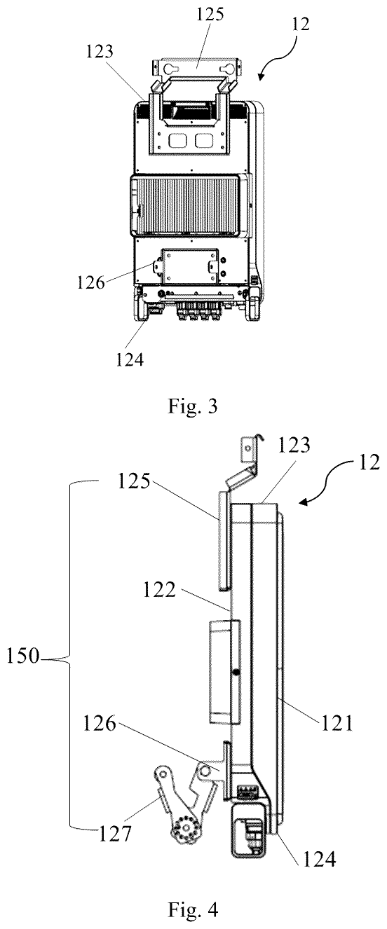

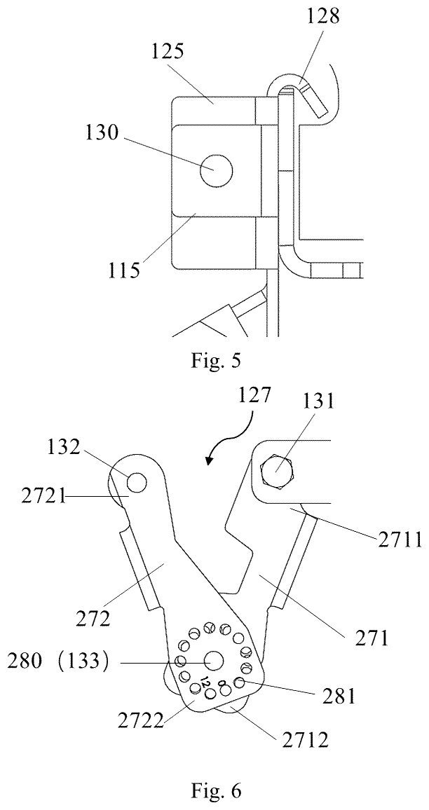

Referring to FIG. 1, FIG. 3 and FIG. 4, the mounting system 100 may also comprise a mounting kit 150. The mounting kit 150 may comprise an upper mounting bracket 125 and a lower mounting bracket 126 disposed on the back 122 of the active antenna module 12, and an intermediate mounting assembly 127 pivotally connected with the lower mounting bracket 126. The upper mounting bracket 125 may be fixed to the back 122 of the active antenna module 12 at a position near the top 123 of the active antenna module 12, while the lower mounting bracket 126 may be fixed to the back 122 of the active antenna module 12 at a position near the bottom 124 of the active antenna module 12. The upper mounting bracket 125 is configured to pivotally connect the top 123 of the active antenna module 12 with the top 113 of the passive antenna module 11 or with the upper mounting assembly 110 to enable the top of the active antenna module 12 to tilt and be displaced along with the top of the passive antenna module 11 during the adjustment of the tilt angle of the passive antenna module 11. The intermediate mounting assembly 127 is configured to pivotally mount a portion of the active antenna module 12 near the bottom 124 to the mounting structure 20. The intermediate mounting assembly 127 may also be configured to allow the bottom 124 of active antenna module 12 to pivot around middle mounting component 127 during the tilting of the passive antenna module 11, while preventing the bottom 124 of active antenna module 12 from being displaced. This helps avoid impacts or collisions between the bottom of active antenna module 12 due to displacement or swinging, thereby preventing damage to the passive antenna module 11 and/or the active antenna module 12 itself. Further details will be described in the following text.

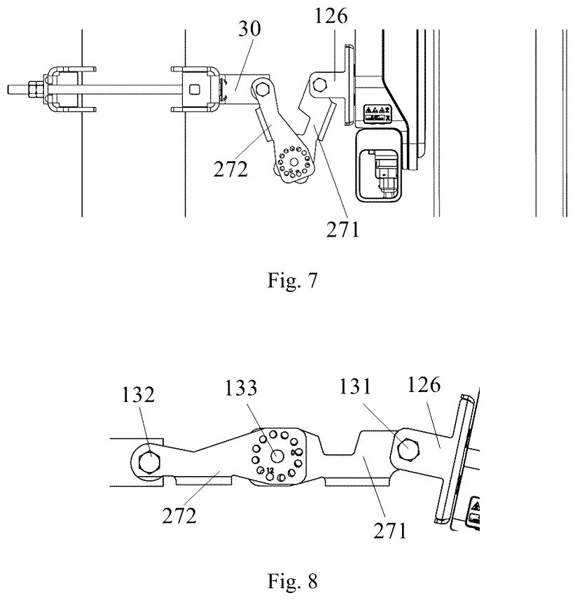

Referring to FIG. 4 and FIG. 5, according to an embodiment of the present disclosure, the upper mounting bracket 125 and the lower mounting bracket 126 may be configured in the form of protrusions, thereby avoiding the use of existing frame structures, reducing the weight of the base station antennas while saving material costs. According to an embodiment of the present disclosure, the upper mounting bracket 125 may be configured to pivotally connect to the upper mounting bracket 115, such that the top 123 of the active antenna module 12 is pivotally connected to the top 113 of the passive antenna module 11. The pivot 130 may be utilized to pivotally connect the upper mounting bracket 125 and the upper mounting bracket 115. According to an embodiment of the present disclosure, the pivot 130 may be formed by a bolt-nut assembly, wherein, when the nut of the bolt-nut assembly is loosened, the upper mounting bracket 115 and the upper mounting bracket 125 may pivot relative to each other around the bolt, and when the nut of the bolt-nut assembly is tightened, the upper mounting bracket 115 and the upper mounting bracket 125 are secured together and cannot pivot relative to each other.

According to another embodiment of the present disclosure, the upper mounting bracket 125 may comprise a hook portion 128. The hook portion 128 may be hooked on the upper mounting bracket 115, which facilitates mounting of the active antenna module 12. For example, during the mounting process, the passive antenna module 11 may be first mounted to the mounting structure 20, and the active antenna module 12 may then be suspended on the passive antenna module 11 by hooking the hook portion 128 on the upper mounting bracket 115 of the passive antenna module 11. This not only simplifies the operation steps and saves the physical effort of the installation personnel, but also frees up their hands for completing other tasks. In some embodiments, the hook portion 128 may have a tilt angle relative to the vertical direction that is at least greater than the maximum tilt angle of the passive antenna module 11 to avoid interference with the upper mounting bracket 115 during the tilting process that would prevent the tilting of the passive antenna module 11. For example, the angle of the hook portion 128 may be greater than 12°, 15°, 20°, even 30°, etc. The angle of the hook portion 128 may be less than 45°.

According to another embodiment of the present disclosure, the upper mounting bracket 125 may also be configured to be pivotally connected to the upper mounting assembly 110. In this embodiment, the active antenna module 12 may be displaced and tilted together with the upper mounting assembly 110 after being released, or it may be displaced and tilted along the upper mounting assembly 110.

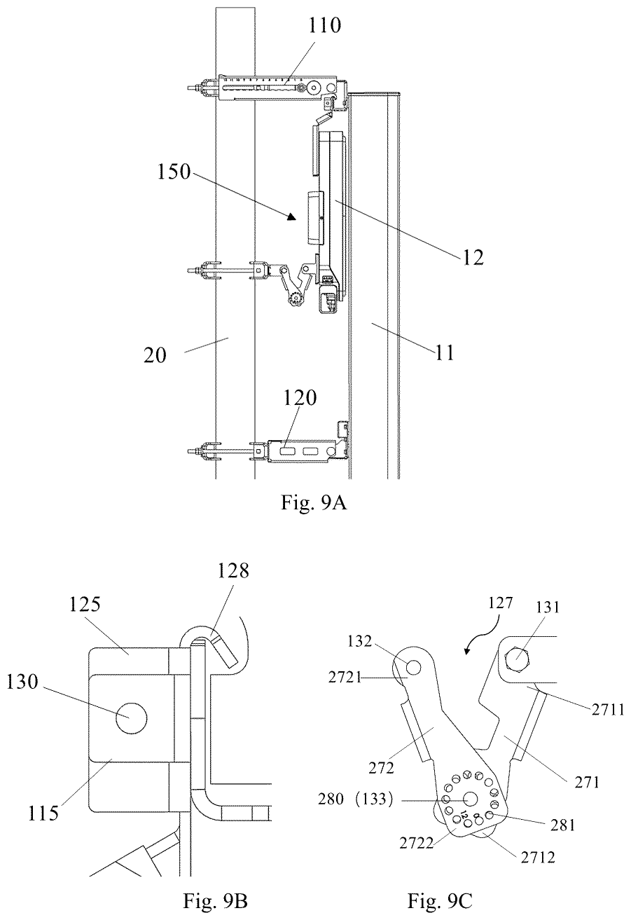

Referring to FIG. 6 to FIG. 8, according to an embodiment of the present disclosure, the intermediate mounting assembly 127 may secure the active antenna module 12 at the desired height on the mounting structure 20 with the aid of the clamping assembly 30, typically between the upper mounting assembly 110 and the lower mounting assembly 120. The intermediate mounting assembly 127 may comprise a first intermediate mounting element 271 and a second intermediate mounting element 272. The first intermediate mounting assembly 127 and the second intermediate mounting element 272 may be configured in the form of a linkage. The first end 2711 of the first intermediate mounting element 271 may be pivotally connected to the lower mounting bracket 126 via a pivot 131, while the first end 2721 of the second intermediate mounting element 272 may be pivotally connected to the clamping assembly 30 via a pivot 132. The second end 2712 of the first intermediate mounting element 271 and the second end 2722 of the second intermediate mounting element 272 may both comprise an intermediate hole 280 and a plurality of adjustment holes 281 distributed along the circumference of the intermediate hole 280. The second end 2712 of the first intermediate mounting element 271 and the second end 2722 of the second intermediate mounting element 272 may be pivotally connected via a pivot 133 extending through the intermediate hole 280. According to an embodiment of the present disclosure, similar to the pivot 130, the pivots 131, 132, and 133 may be formed by a bolt-nut assembly, wherein, when the nut of the bolt-nut assembly is loosened, the corresponding components may pivot relative to each other around the bolt, and when the nut of the bolt-nut assembly is tightened, the corresponding components are secured together and cannot pivot relative to each other.

Each of the plurality of adjustment holes 281 of the second end 2712 of the first intermediate mounting element 271 and the second end 2722 of the second intermediate mounting element 272 correspond to a tilt angle of the active antenna module 12. For example, according to an embodiment of the present disclosure, the base station antenna 10 (comprising the passive antenna module 11 thereof and the active antenna module 12) may have a tilt angle between 0° and 12°; the second end 2712 of the first intermediate mounting element 271 and the second end 2722 of the second intermediate mounting element 272 may, in contrast, comprise, for example, 13 adjustment holes, each of which may correspond to 1°. It is to be noted here that although each adjustment hole corresponds to 1°, the plurality of adjustment holes (e.g., the 13 adjustment holes) are not evenly distributed along the circumference. The center position of each adjustment hole needs to be calculated based on the distance moved for every 1° tilt of the active antenna module 12, such that it precisely corresponds to the tilt angle of the active antenna module 12.

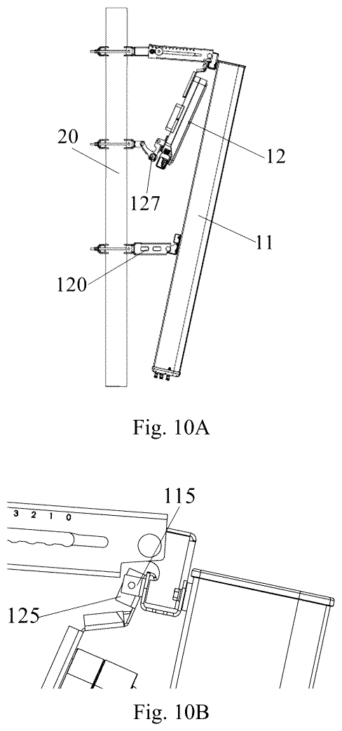

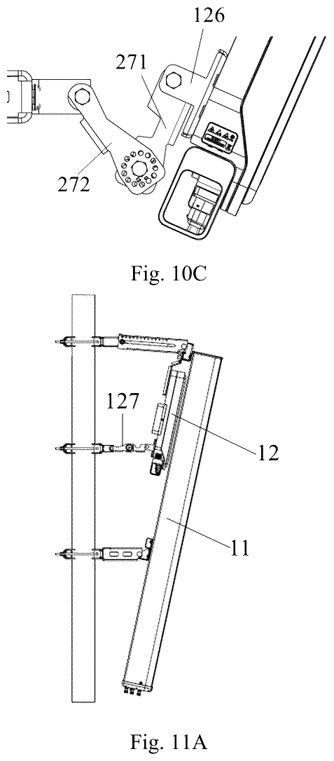

When the active antenna module 12 is at a predetermined tilt angle, one of the adjustment holes among the plurality of adjustment holes at the second end 2712 of the first intermediate mounting element 271 that corresponds to the predetermined tilt angle is aligned with one of the adjustment holes among the plurality of adjustment holes at the second end 2722 of the second intermediate mounting element 272. This alignment allows fastening elements to simultaneously extend through the two aligned adjustment holes of the first intermediate mounting element 271 and the second intermediate mounting element 272, thereby securing the active antenna module 12 at the predetermined tilt angle. This ensures precise positioning of the active antenna module 12. For example, FIG. 7 illustrates the positional relationship between the first intermediate mounting element 271 and the second intermediate mounting element 272 when the active antenna module 12 is at a 0° tilt angle (i.e., positioned along the vertical direction). At this point, the adjustment hole at the second end 2712 of the first intermediate mounting element 271 corresponding to 0° is aligned with the adjustment hole at the second end 2722 of the second intermediate mounting element 272 corresponding to 0°; FIG. 8 illustrates the positional relationship between the first intermediate mounting element 271 and the second intermediate mounting element 272 when the active antenna module 12 is at a 10° tilt angle. At this point, the adjustment hole at the second end 2712 of the first intermediate mounting element 271 corresponding to 12° is aligned with the adjustment hole at the second end 2722 of the second intermediate mounting element 272 corresponding to 12°.

Using the intermediate mounting assembly 127 according to the present disclosure allows for independent adjustment of the tilt angle of the active antenna module 12 and the passive antenna module 11. For example, during the tilting of the passive antenna module 11, the first intermediate mounting element 271 and second intermediate mounting element 272 of the intermediate mounting assembly 127 may be kept at positions corresponding to a 0° tilt angle. At this point, although the top of the active antenna module 12 may be tilted along with the top of the passive antenna module 11, the bottom of the active antenna 12 may only pivot around the pivot 131 of the first end 2711 of the first intermediate mounting element 271 without being displaced. This helps avoid impacts or collisions between the passive antenna module 11 and the active antenna module 12 due to displacement or swinging of the bottom of the active antenna module 12 during tilting, thereby avoiding damage to the passive antenna module 11 and/or the active antenna module 12 itself. After the passive antenna module 11 is tilted to the predetermined tilt angle, fastening elements extending through the adjustment holes corresponding to the 0° tilt angle of the first intermediate mounting element 271 and second intermediate mounting element 272 are removed, such that the first intermediate mounting element 271 and second intermediate mounting element 272 are able to pivot around the pivot 133 extending through the central hole 280, causing the bottom 124 of the active antenna module 12 to be displaced towards the passive antenna module 11. When the bottom 124 of the active antenna module 12 is displaced towards the passive antenna module 11 to position the active antenna module 12 at the predetermined tilt angle, the two adjustment holes corresponding to this predetermined tilt angle on the first intermediate mounting element 271 and the second intermediate mounting element 272 are aligned with each other. At this point, fastening elements are inserted into the two adjustment holes of the first intermediate mounting element 271 and the second intermediate mounting element 272 that are aligned with one another, thereby maintaining the active antenna module 12 at the predetermined tilt angle. Additionally, in some instances, when a misalignment of the two adjustment holes due to a positional error of the active antenna module 12 causes them not to align with each other, the active antenna module 12 may be manually adjusted to the predetermined tilt angle by aligning the two adjustment holes with each other, ensuring the precise positioning of the active antenna module 12. In some embodiments, angle indicators may also be provided near each adjustment hole to clearly indicate to the installation personnel the tilt angle corresponding to each adjustment hole, thereby facilitating the operations of the installation personnel.

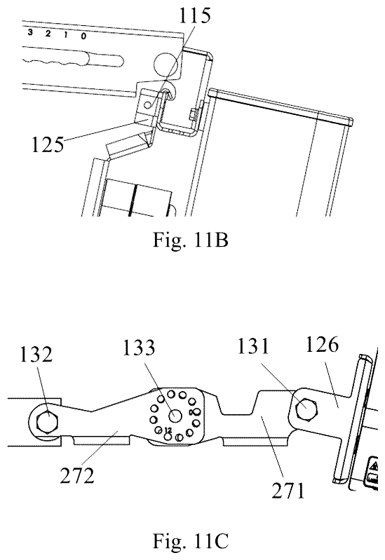

Next, referring to FIG. 9A to FIG. 11C, the method of mounting the base station antenna 10 and adjusting its tilt angle using the mounting system 100 according to the present disclosure will be described.

In FIG. 9A, the passive antenna module 11 may first be mounted at a 0° tilt angle onto the mounting structure 20 using the upper mounting assembly 110 and lower mounting assembly 120 of the mounting system 100, and the active antenna module 12 may be mounted on the mounting structure 20 at a 0° tilt angle on the back 112 of the passive antenna module 11 using the mounting kit 150 of the mounting system, wherein the top 123 of the active antenna module 12 is pivotally connected either to the top 113 of the passive antenna module 11 or to the upper mounting assembly 110.

In some embodiments, the upper mounting bracket 115 and lower mounting bracket 116, disposed on the back 112 of the passive antenna module 11, may be connected respectively to the upper mounting assembly 110 and the lower mounting assembly 120 to mount the passive antenna module 11 onto the mounting structure.

In some embodiments, after mounting the passive antenna module 11 to the mounting structure 20, the active antenna module 12 may first be hooked on the upper mounting bracket 115 of the passive antenna module 11 (as shown in FIG. 9B) with the hook portion 128 of the upper mounting bracket 125 of the mounting kit 150 before mounting the bottom 124 of the active antenna module 12 to the mounting structure 20 and maintaining the active antenna module 12 at a 0° tilt angle using the intermediate mounting assembly 127 of the mounting kit 150.

To adjust the tilt angle of the base station antenna 10, as shown in FIG. 10A, the passive antenna module 11 may first be tilted around the lower mounting assembly 120 of the mounting system 100 to the predetermined tilt angle (e.g., tilted to) 12°. During the tilting process of the passive antenna module 11, the top 123 of the active antenna module 12 may be displaced along with the top 113 of the passive antenna module 11 (see FIG. 10A) and pivot relative to the top 113 of the passive antenna module 11 (see FIG. 10B), while the bottom 124 of the active antenna module 12 may only pivot around the intermediate mounting assembly 127 of the mounting kit 150 without being displaced (see FIG. 10C). During this process, as shown in FIG. 10A, the first intermediate mounting element 271 and the second intermediate mounting element 272 of the intermediate mounting assembly 127 always remain in positions corresponding to a 0° tilt angle (for example, a fastening element may be inserted into the two aligned adjustment holes corresponding to the 0° tilt angle in the first intermediate mounting element 271 and the second intermediate mounting element 272 to maintain this), to prevent the bottom 124 of the active antenna module 12 from being displaced. This avoids collisions or impacts between the bottom 124 of the active antenna module 12 and the passive antenna module 11 due to displacement or swinging.

After the passive antenna module 11 is tilted to the predetermined tilt angle, as shown in FIG. 11A, the intermediate mounting assembly 127 of the mounting kit 150 may be released (for example, by removing the fastening element from the first intermediate mounting element 271 and the second intermediate mounting element 272) to allow the bottom 124 of the active antenna module 12 to be displaced towards the passive antenna module 11 until the bottom 124 of the active antenna module 12 is positioned such that the active antenna module 12 is also at the predetermined tilt angle. (see FIG. 11A). In this process, the top 123 of the active antenna module 12 may be pivoted in reverse relative to the top 113 of the passive antenna module 11 (e.g., the upper mounting bracket 115 of the passive antenna module 11) (see FIG. 11B) and the first intermediate mounting element 271 and the second intermediate mounting element 272 of the intermediate mounting assembly 127 may be pivoted relative to the pivot 133 (see FIG. 11C). After the active antenna module 12 has also been displaced to the predetermined tilt angle, the two adjustment holes corresponding to this predetermined tilt angle on the first intermediate mounting element 271 and the second intermediate mounting element 272 of the intermediate mounting assembly 127 are aligned with each other. At this point, a fastening element may be inserted into the two aligned adjustment holes of the first intermediate mounting element 271 and the second intermediate mounting element 272 to maintain the active antenna module 12 at the predetermined tilt angle.

In some embodiments, once either the passive antenna module 11 or the active antenna module 12 is adjusted to the predetermined tilt angle, the corresponding rotatable parts are fastened to prevent further undesired rotation of the passive antenna module 11 and/or the active antenna module 12. This helps to precisely position the passive antenna module 11 and the active antenna module 12 at the adjusted tilt angle.

Exemplary examples according to the present disclosure have been described above with reference to the attached drawings. However, those of ordinary skill in the art should understand that various changes and modifications can be made to the exemplary examples of the present disclosure without departing from the gist and scope of the present disclosure. All changes and modifications are included in the protection scope of the present disclosure defined by the claims. The present disclosure is defined by the attached claims, and equivalents of these claims are also included.

What is claimed is:

1. A mounting system for base station antennas, wherein the base station antenna comprises a passive antenna module and an active antenna module, and the mounting system comprises:
an upper mounting assembly configured to mount the top of the passive antenna module in a tilt-adjustable manner to a mounting structure;
a lower mounting assembly configured to pivotally mount a portion near the bottom of the passive antenna module to the mounting structure; and
a mounting kit comprising a first upper mounting bracket, a first lower mounting bracket, and an intermediate mounting assembly pivotally connected to the first lower mounting bracket, wherein the first upper mounting bracket is fixed to the back of the active antenna module facing the mounting structure at a position near the top of the active antenna module, while the first lower mounting bracket is fixed to the back of the active antenna module at a position near the bottom of the active antenna module;
wherein the first upper mounting bracket is configured to pivotally connect the top of the active antenna module with the top of the passive antenna module or with the upper mounting assembly to enable the top of the active antenna module to tilt and be displaced along with the top of the passive antenna module during the adjustment of the tilt angle of the passive antenna module; and
wherein the intermediate mounting assembly is configured to pivotally mount a portion near the bottom of the active antenna module to the mounting structure and to allow the bottom of the active antenna module to pivot around the intermediate mounting assembly during the tilting process of the passive antenna module without allowing the bottom of the active antenna module to be displaced.

2. The mounting system according to claim 1, wherein the intermediate mounting assembly comprises a first intermediate mounting element and a second intermediate mounting element, wherein the first end of the first intermediate mounting element is pivotally connected to the first lower mounting bracket, while the first end of the second intermediate mounting element is pivotally connected to a clamping assembly suitable to be mounted on the mounting structure; and
wherein both the second end of the first intermediate mounting element and the second end of the second intermediate mounting element comprise a central hole and a plurality of adjustment holes distributed along the circumference of the central hole, of which the second end of the first intermediate mounting element and the second end of the second intermediate mounting element are pivotally connected via a pivot extending through the central hole, and each of the plurality of adjustment holes at the second end of the first intermediate mounting element and the second end of the second intermediate mounting element corresponds to a tilt angle of the active antenna module, such that when the active antenna module is at a predetermined tilt angle, one adjustment hole corresponding to the predetermined tilt angle at the second end of the first intermediate mounting element is aligned with one adjustment hole corresponding to the predetermined tilt angle at the second end of the second intermediate mounting element.

3. The mounting system according to claim 2, wherein the plurality of adjustment holes are distributed unevenly along the circumference.

4. The mounting system according to claim 2, wherein the intermediate mounting assembly is configured to allow the active antenna module to have a tilt angle between 0° and 12°.

5. The mounting system according to claim 2, wherein, when the active antenna module is at a predetermined tilt angle, fastening elements extend through two aligned adjustment holes of the first intermediate mounting element and the second intermediate mounting element to secure the active antenna module at the predetermined tilt angle.

6. The mounting system according to claim 1, wherein the mounting system further comprises a second upper mounting bracket and a second lower mounting bracket, of which the second upper mounting bracket is fixed to the back of the passive antenna module near the top and pivotally connected to the upper mounting assembly, while the second lower mounting bracket is fixed below the top of the passive antenna module, on the back of the passive antenna module, and is pivotally connected to the lower mounting assembly.

7. The mounting system according to claim 6, wherein the first upper mounting bracket is pivotally connected to the second upper mounting bracket.

8. The mounting system according to claim 7, wherein the first upper mounting bracket comprises a hook portion, which is capable of hooking onto the second upper mounting bracket.

9. The mounting system according to claim 8, wherein the hook portion has a tilt angle relative to the vertical direction, wherein the angle is at least greater than the maximum tilt angle of the passive antenna module.

10. The mounting system according to claim 1, wherein both the first upper mounting bracket and the second upper mounting bracket are configured in the form of protrusions.

11. The mounting system according to claim 1, wherein the upper mounting assembly is configured as an extendable sleeve that is capable of tilting downward and expanding along the axial direction.

12. The mounting system according to claim 1, wherein the upper mounting assembly is provided with an arcuate groove, which is used to connect the top of the passive antenna module, and the connecting element of the upper mounting assembly is positioned in the arcuate groove and is capable of sliding along the arcuate groove.

13. The mounting system according to claim 1, wherein the mounting system further comprises a clamping assembly, the upper mounting assembly and the lower mounting assembly mount the passive antenna module to the mounting structure with the assistance of the clamping assembly, while the intermediate mounting assembly mounts the active antenna module to the mounting structure with the assistance of the clamping assembly.

14. A method for mounting a base station antenna using the mounting system according to claim 1, wherein the base station antenna includes a passive antenna module and an active antenna module, the method comprising:
using the upper mounting assembly and the lower mounting assembly of the mounting system to mount the passive antenna module at a 0° tilt angle to the mounting structure;
using the mounting kit of the mounting system to mount the active antenna module at a 0° tilt angle on the back of the passive antenna module facing the mounting structure, wherein the top of the active antenna module is connected to the top of the passive antenna module or pivotally connected to the upper mounting assembly;
tilting the passive antenna module around the lower mounting assembly of the mounting system to a predetermined tilt angle, wherein during the tilting process of the passive antenna module, the top of the active antenna module is displaced along with the top of the passive antenna module and pivots relative to the top of the passive antenna module, while the bottom of the active antenna module only pivots around the intermediate mounting assembly of the mounting kit without being displaced;
after the passive antenna module is tilted to the predetermined tilt angle, releasing the intermediate mounting assembly of the mounting kit to allow the bottom of the active antenna module to be displaced towards the passive antenna module until the bottom of the active antenna module is positioned such that the active antenna module is also at the predetermined tilt angle.

15. The method according to claim 14, wherein the mounting system comprises a second upper mounting bracket and a second lower mounting bracket positioned on the back of the passive antenna module, and the method further comprises connecting the second upper mounting bracket and the second lower mounting bracket respectively to the upper mounting assembly and the lower mounting assembly to mount the passive antenna module onto the mounting structure.

16. The method according to claim 15, wherein the first upper mounting bracket of the mounting kit comprises a hook portion, and the method further comprises, after mounting the passive antenna module onto the mounting structure, using the hook portion to hook the active antenna module onto the second upper mounting bracket of the passive antenna module, then using the intermediate mounting assembly of the mounting kit to mount the bottom of the active antenna module onto the mounting structure and keep the active antenna module at the 0° tilt angle.

17. The method according to claim 14, wherein the intermediate mounting assembly comprises a first intermediate mounting element and a second intermediate mounting element pivotally connected to each other, during the tilting process of the passive antenna module, the first intermediate mounting element and the second intermediate mounting element always remain in positions corresponding to the 0° tilt angle.

18. The method according to claim 17, wherein both ends of the first intermediate mounting element and the second intermediate mounting element, which are connected to each other, comprise intermediate holes and a plurality of adjustment holes surrounding the central hole and distributed along its circumference, wherein each of the plurality of adjustment holes corresponds to a tilt angle of the active antenna module, when the active antenna module is at the 0° tilt angle, the adjustment hole corresponding to the 0° tilt angle among the plurality of adjustment holes of the first intermediate mounting element is aligned with the adjustment hole corresponding to the 0° tilt angle among the plurality of adjustment holes of the second intermediate mounting element, and the method comprises inserting fastening elements into the two adjustment holes corresponding to the 0° tilt angle to keep the first intermediate mounting element and the second intermediate mounting element always in positions corresponding to the 0° tilt angle.

19. The method according to claim 18, wherein the method comprises removing the fastening elements after the passive antenna module has been tilted to the predetermined tilt angle, causing the bottom of the active antenna module to be displaced towards the passive antenna module.

20. The method according to claim 19, wherein, after the active antenna module has also reached the predetermined tilt angle, the two adjustment holes of the first intermediate mounting element and the second intermediate mounting element of the intermediate mounting assembly corresponding to the predetermined tilt angle are aligned with each other, and the method further comprises inserting fastening elements into the two adjustment holes of the first intermediate mounting element and the second intermediate mounting element corresponding to the predetermined tilt angle to maintain the active antenna module at the predetermined tilt angle.
